(19) United States
(12) Patent Application Publication
(10) Pub. No.: US 2025/0361900 A1
(43) Pub. Date: Nov. 27, 2025

(54) SCREW LOCK

(71) Applicant: Tesla, Inc., Austin, TX (US)

(72) Inventor: Yongquan Yu, Kyle, TX (US)

(21) Appl. No.: 18/873,998

(22) PCT Filed: Jun. 12, 2023
(86) PCT No.: PCT/US2023/025077

§ 371 Date: Dec. 11, 2024

Related U.S. Application Data
(60) Provisional application No. 63/366,387, filed on Jun. 14, 2022.

(51) Int. Cl. F16B 21/07; F16B 5/02; F16B 5/06

(52) U.S. Cl. CPC F16B 21/07; F16B 5/02; F16B 5/065

(57) ABSTRACT

A screw lock fastener that can have high retention and be made with non-metal materials to avoid corrosion issues, especially when used with stainless steel parts. In some embodiments, a screw lock can be used with a tapping screw. The screw lock can be re-used by unscrewing the tapping screw. The screw lock can also include a sealer to have waterproof feature.

### CROSS-REFERENCE TO RELATED APPLICATIONS

This application claims priority to U.S. Provisional Patent Application No. 63/366,387, filed Jun. 14, 2022, the entire contents of each of which are incorporated by reference in their entirety and for all purposes.

### TECHNICAL FIELD

The present invention relates to a fastener. More particularly, the fastener can provide high retention and be made without steel materials to avoid corrosion issues.

### BACKGROUND

Many fasteners are made of metal materials for better strength and durability. In the auto industry, for example, metal fasteners, such as fasteners constructed as stainless steel materials, have been widely used to hold components together for vehicle impact concerns. However, under some environments, oil, humidity, and heat can cause corrosion issues in components and fasteners, especially when stainless steel parts are used. Steel fasteners, such as galvanized spring steel fasteners, can get rust in weeks when used to fasten stainless steel parts. Stainless steel fasteners are expensive and difficult to make in mass production due to the stiffness of stainless steel. A snap fit fastener made of stainless steel does not provide desirable insertion or extraction force performance because of its stiffness.

### SUMMARY OF THE INVENTION

The disclosure relates generally to a non-metal screw lock fastener that provides a high retention. More specifically, various embodiments of this disclosure relate to a non-metal screw lock that can fasten stainless steel parts of a vehicle.

One aspect of this disclosure includes a fastener comprising a lock extending between a front end of the fastener and a rear end of the fastener. The lock comprises a body, a disk at the rear end, a head at the front end, and two blocks extending from opposite sides of the body of the lock proximate the rear end. The fastener further comprises a retainer disposed over the lock. The retainer comprises a cavity extending between two openings on opposite sides of the retainer. The retainer also comprises one or more snap fit joints disposed on an external surface of the retainer and proximate the rear end and configured to fasten a first part. The retainer further comprises a screw configured to enter through a second part and into the body of the lock. The body of the lock is substantially inside the cavity of the retainer. Rotating the screw in a first direction causes the lock to rotate and the two blocks to protrude from the openings of the retainer, thereby locking the first part and the second part between the two blocks and the screw.

One variation of the aspect above is, wherein the retainer has a substantially rectangular profile.

One variation of the aspect above further comprises a sealer configured to extend over the disk of the lock.

One variation of the aspect above is, wherein the sealer is sized and shaped to radially extend from the disk of the lock to create a sealing between the first part and the second part.

One variation of the aspect above is, wherein the retainer further comprises two or more arms configured to receive and engage the head of the lock to retain the lock inside the retainer.

One variation of the aspect above is, wherein the head of the lock is tapered such that the head of the lock can move past the two or more arms of the retainer and be stopped from moving back.

One variation of the aspect above is, wherein the lock comprises nylon and glass fiber.

One variation of the aspect above is, wherein the retainer comprises plastic.

One variation of the aspect above is, wherein the sealer comprises rubber.

One variation of the aspect above is, wherein the screw comprises a tapping screw.

One variation of the aspect above is, wherein the fastener is waterproof.

One variation of the aspect above is, wherein rotating the screw in a second direction opposite the first direction causes the lock to rotate and the two blocks of the lock to enter the cavity of the retainer.

Another aspect of this disclosure is a fastener comprising a lock and a retainer. The lock comprises a body, a disk extending radially from a first end of the body, and one or more blocks extending from opposite sides of the body. The retainer is disposed over the lock, the retainer comprising a cavity extending between two openings on opposite sides of the retainer. The retainer further comprises a screw configured to enter through a second part and into the body of the lock. Rotating the screw in a first direction causes the lock to rotate and the one or more blocks to protrude from the openings of the retainer, thereby securing a first part between the disk and the one or more blocks, and securing a second part between the disk of the lock and the screw.

One variation of the aspect above is, wherein the retainer further comprises one or more snap fit joints disposed on an external surface of the retainer, and configured to fasten the first part.

One variation of the aspect above is, wherein the retainer has a substantially rectangular profile.

One variation of the aspect above is, wherein the body of the lock is substantially inside the cavity of the retainer.

One variation of the aspect above is, wherein the one or more blocks of the lock are proximate the disk of the lock.

One variation of the aspect above further comprises a sealer sized and shaped to radially extend from the disk of the lock and create a sealing between the first part and the second part.

### BRIEF DESCRIPTION OF THE DRAWINGS

The present invention is described with reference to the accompanying drawings, in which like reference characters reference like elements, and wherein:

FIG. 1A is a perspective view of an embodiment of a screw lock in a locked position.

FIG. 1B is a perspective view of the screw lock in FIG. 1A in an unlocked position.

FIG. 2 is an exploded view of the screw lock in FIG. 1A in an unlocked position.

FIG. 3 is a top view of the screw lock in FIG. 1A.

FIG. 4A is a side view of the screw lock in FIG. 1A in an unlocked position.

FIG. 4B is a cross-sectional view of the screw lock taken along a line A-A in FIG. 4A.

FIG. 5A is a front view of the screw lock in FIG. 1A in an unlocked position.

FIG. 5B is a cross-sectional view of the screw lock taken along a line B-B in FIG. 5A.

FIG. 5C is a cross-sectional view of the screw lock taken along a ling C-C in FIG. 5A.

FIG. 6A is a side perspective view of the screw lock in FIG. 1A to be installed onto a first panel.

FIG. 6B is a side perspective view of the screw lock in FIG. 6A installed on the first panel in FIG. 6A.

FIG. 7A is a perspective view of the screw lock in FIG. 1A upside down and in an assembly with a first panel, a second panel, and a tapping screw to be installed.

FIG. 7B is a perspective view of the assembly in FIG. 7A with the tapping screw installed illustrating a torque that can be applied to the tapping screw to lock the screw lock.

FIG. 7C is a perspective view of the assembly in FIG. 7B with the screw lock in a locked position.

FIG. 8 is a side cross-sectional view of the screw lock in FIG. 4A in an assembly with a first panel, a second panel, and a tapping screw in a locked position, taken along the plane of the page in FIG. 4A.

### DETAILED DESCRIPTION

Generally described, one or more aspects of the present disclosure relate to screw lock fasteners. In certain embodiments, this disclosure relates to a screw lock fastener that can be made of non-metal materials and provide high retention (e.g., 1000-2000N). In other embodiments, the screw lock fastener can be used on stainless steel parts to avoid corrosion issues (e.g., rust) with metal fasteners. The screw lock can also include a sealer to provide waterproof fastening. The screw lock illustratively can include three components, a lock, a retainer, and a sealer.

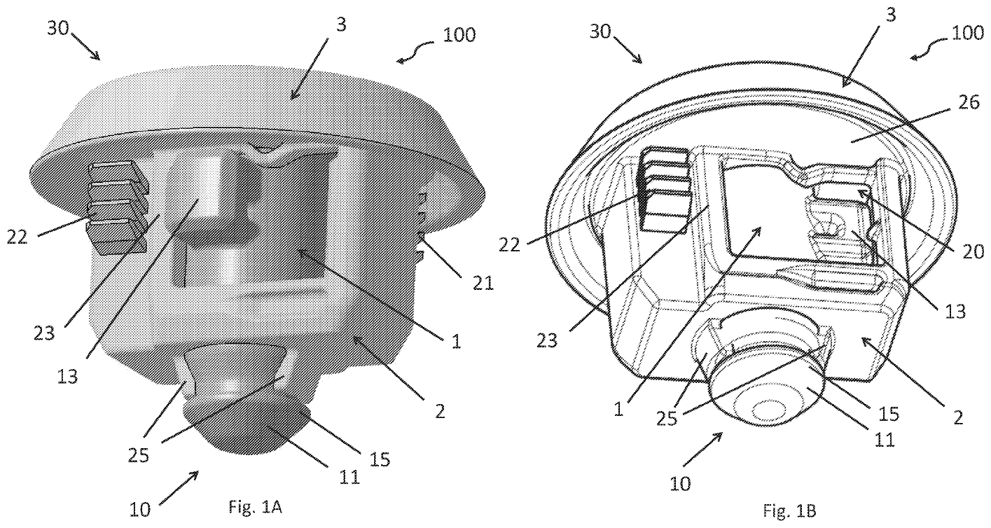

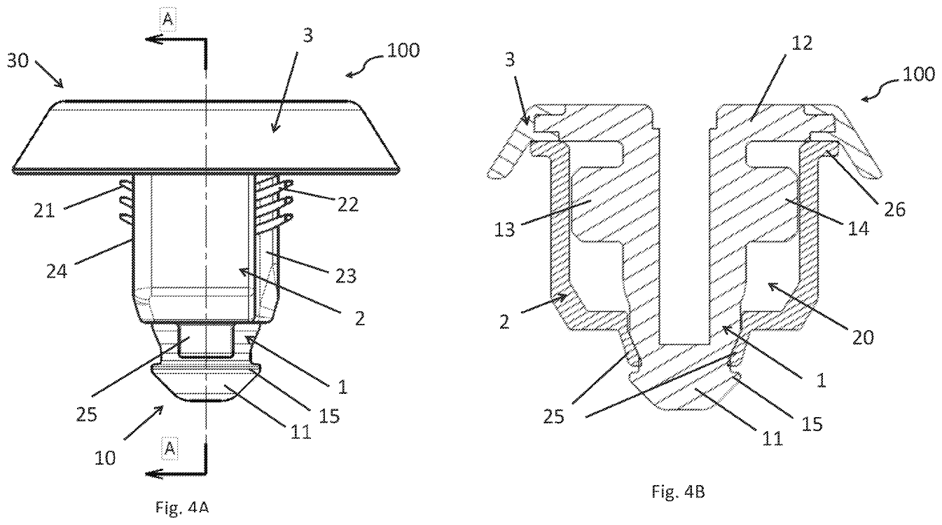

FIG. 1A-B show perspective views of an embodiment of a screw lock 100 including a lock 1, a retainer 2, and a sealer 3. The lock 1 can extend between a front end 10 and a rear end 30. The lock 1 can include a head 11 at the front end 10 and a disk 12 at the rear end 30 as illustrated in FIG. 3. The retainer 2 can retain the lock 1 inside a cavity 20 of the retainer. In some embodiments, the lock 1 can be retained substantially inside the retainer 2 except for the disk 12 and the head 11 (see FIG. 4B). The cavity 20 can extend between opposite sides of the retainer 2 and have openings on opposite sides of the retainer 2. In some embodiments, the retainer 2 can retain the lock 1 by having two or more arms 25 configured to engage the head 11 of the lock 1 for delivery condition. As shown in FIG. 1A-B, the head 11 can be tapered, with a tip of the head 11 be smaller, to allow the head 11 to slide through the two or more arms 25. The head 11 can also include a flange 15 extending around the head 11 such that after the head 11 has passed through the two or more arms 25, the flange 15 can stop the head 11 from moving relative to the two or more arms 25 and the lock 1 from exiting the retainer 2.

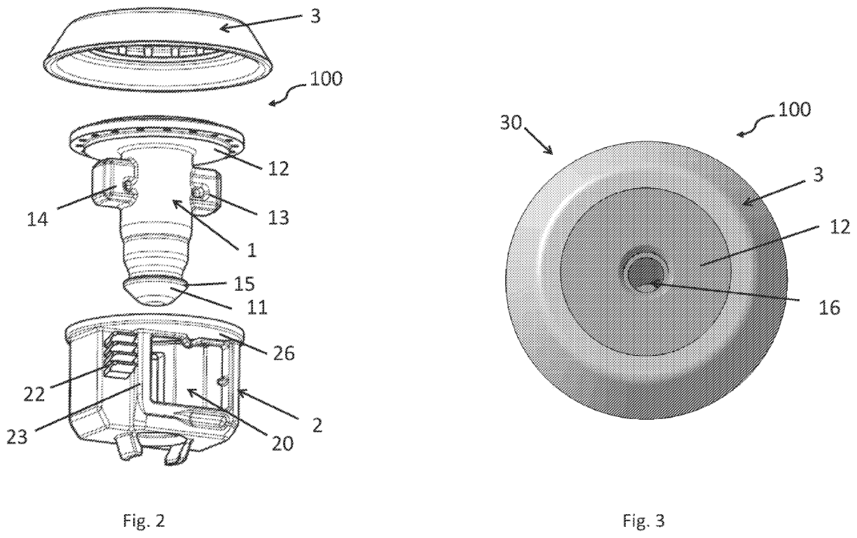

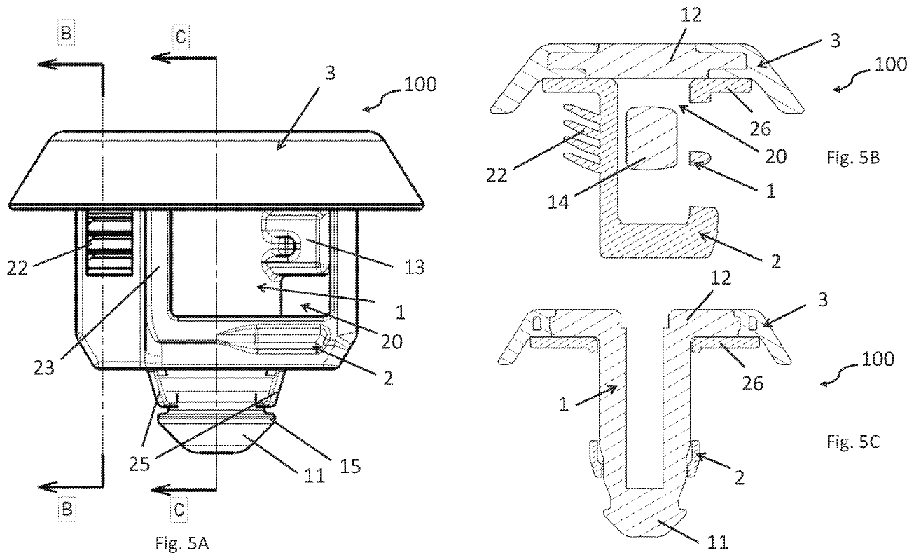

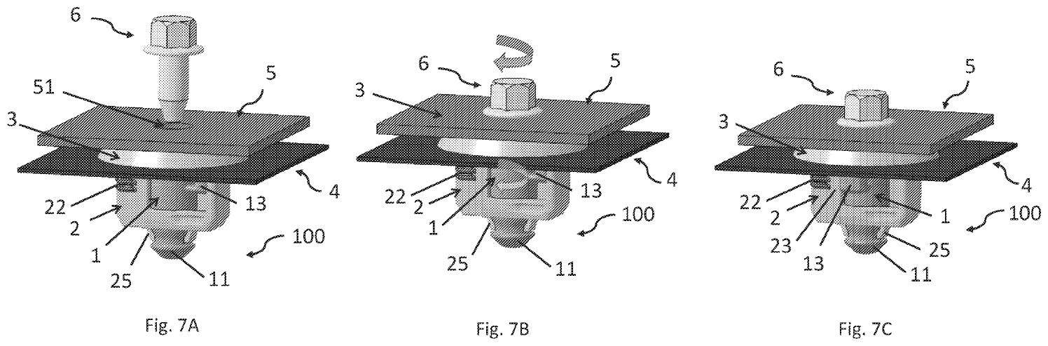

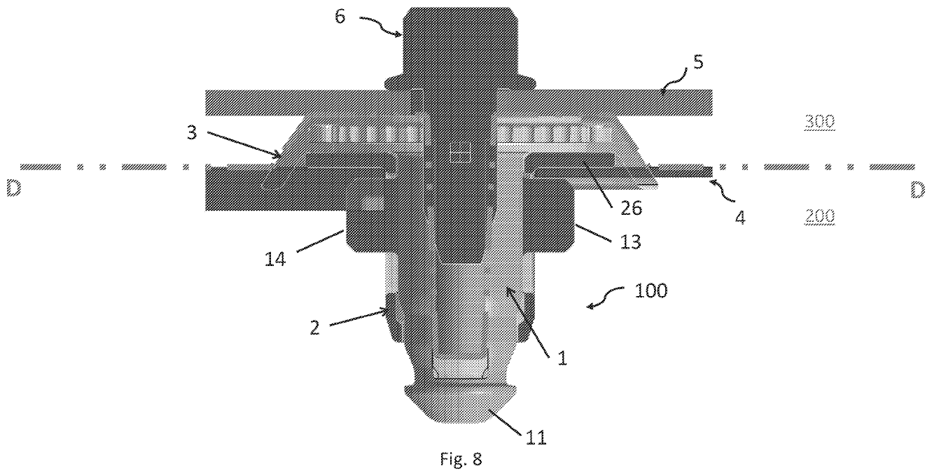

The lock 1 can include two blocks extending from opposite sides of the lock 1 as shown in FIG. 2. In some embodiments, rotating the lock 1 inside the cavity 20 of the retainer 2 can allow the blocks 13 and 14 to protrude from the openings of the cavity 20. The openings can offset each other on opposite sides of the retainer 2 such that the blocks 13 and 14 can protrude and rotate from opposite sides of the retainer 2. As shown in FIG. 1A, the screw lock 100 in a locked position can have the block 13 protruded out from one side of the retainer 2 and stop at the wall 23 of the retainer 2. Correspondingly, the screw lock 100 can have a wall 24 (see FIG. 4A) on the opposite of the retainer 2 configured to stop the block 14. In some embodiments, the retainer 2 can include a platform 26 at the rear end 30. When the screw lock 100 is in an unlocked position, the blocks 13 and 14 can be substantially inside the retainer 2 as shown in FIGS. 4B and 5B. When the screw lock 100 is in the locked position, at least one part can be fastened between the protruding blocks 13 and 14 and the platform 26 as shown in FIGS. 7C and 8.

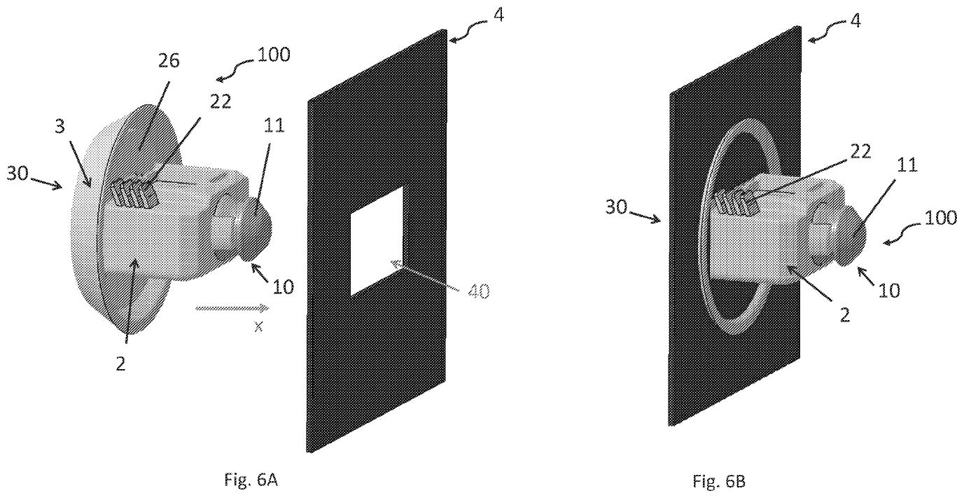

In some embodiments, as shown in FIGS. 2-3, the screw lock 100 can include a sealer 3 that can be configured to wrap around the disk 12 of the lock 1. The disk 12 can be configured to be rotatable inside and relative to the sealer 3. In some embodiments, the screw lock 100 can also include snap fit joints 21 and 22 disposed on opposite sides of the retainer 2, offset each other, as shown in FIG. 4A. Illustratively, the screw lock 100 can be installed on a first part that is to be fastened to a second part. FIGS. 6A and 6B illustrate an embodiment of the screw lock 100 that can fasten a first part 4 between the rear end 30 of the screw lock 100 and the snap fit joints 21 and 22. The first part 4 can be prepared with a hole 40 to allow the retainer to go through in a direction x as shown in FIG. 6A. In the illustrated embodiments, a profile of the retainer 2 and the hole 40 can both be substantially rectangular. FIG. 6B shows the first part 4 can be fastened between the platform 26 of the retainer 2 and the snap fit joints 22 of the retainer 2 such that the screw lock 100 can be installed on the first part 4. In the auto industry, for example, the screw lock can be pre-installed on a trim panel of a vehicle during the Body in White (BIW) stage before assembly.

In some embodiments, the screw lock can be locked in place with a screw (e.g., a stainless steel tapping screw) as shown in FIGS. 7A-7C. For example, a screw lock can be used with a tapping screw to attach a body panel to the trim panel of a vehicle. After the screw lock 100 is installed on a first part 4, a second part 5 can be placed in contact with the sealer 3, aligning a hole 51 on the second plate 5 and a hole 16 on the disk 12 (see FIG. 3). As shown in FIG. 7A, a tapping screw 6 can enter through the hole 51 of the second plate 5, the hole 16 on the disk 12, and into the lock 1 such that the second plate 5 can be fastened between the tapping screw 6 and the sealer 3. Then, a torque can be applied on the tapping screw 6 to rotate the tapping screw 6 in a first direction (e.g., clockwise) to further tighten the second part and bring the lock 1 to rotate in the first direction (e.g., clockwise) as shown in FIG. 7B. The torque can bring the lock 1 to rotate for a certain degree (e.g., 90 degree) and protrude out of the cavity 20 of the retainer 2 until the blocks 13 and 14 are stopped at the walls 23 and 24 (see FIG. 4A). In the locked position as shown in FIG. 7C, the first plate 4 and the second plate 5 can be fastened between the tapping screw 6 and the blocks 13 and 14. Further, in certain embodiments, the tapping screw 6 can be unscrewed and removed from a screw lock so that the screw lock can be re-used. Illustratively, the tapping screw 6 can be removed by rotating the tapping screw 6, along with the lock 1, in a second direction (e.g., counterclockwise) opposite to the first direction. For example, a body panel of a vehicle attached by the screw lock can be removed by unscrewing and removing the tapping screw. The trim panel installed with the screw lock can then be re-used and fastened with the same body panel or another body panel.

When fastening stainless steel parts, metal materials can corrode and get rust very soon, especially under environments having humidity, oil, and heat. In some embodiments, various parts of the screw lock can be made of non-metal materials including plastic, polymide, nylon, glass fiber reinforced polymide (e.g., PA6-GF30), polyacrylamide, glass epoxy laminate (e.g., G10/FR-4), thermoplastic, thermoplastic polyurethane, polyoxymethylene (POM), TPV, and etc. For example, the lock 1 can be made of a non-metal material that can provide strength (e.g., PA6-GF30) such that the blocks 13 and 14 can provide high retention (e.g., 1000N-2000N) when the screw lock 100 is in a locked position (see FIG. 7C). The retainer 2 can be made of a material (e.g., PA66) that is not too rigid such that a special tool is not required to deform the snap fit joints 21 and 22 and insert the screw lock 100 into the hole 40 of the first plate 4 (see FIG. 6A-B). Finally, the sealer can be made of an elastic material (e.g., TPV) to provide waterproof feature. For example, as illustrated in FIG. 8, the sealer 3 can prevent moisture from a moisture environment 200 (e.g., exterior) to pass a line DD and enter the dry environment 300 (e.g., interior).

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A fastener, comprising:
a lock extending between a front end of the fastener and a rear end of the fastener, the lock comprising a body, a disk at the rear end, a head at the front end, and two blocks extending from opposite sides of the body of the lock proximate the rear end;
a retainer disposed over the lock, the retainer comprising:
a cavity extending between two openings on opposite sides of the retainer, and
one or more snap fit joints disposed on an external surface of the retainer and proximate the rear end and configured to fasten a first part; and
a screw configured to enter through a second part and into the body of the lock;
wherein the body of the lock is substantially inside the cavity of the retainer, and
wherein rotating the screw in a first direction causes the lock to rotate and the two blocks to protrude from the openings of the retainer, thereby locking the first part and the second part between the two blocks and the screw.

2. The fastener of claim 1, wherein the retainer has a substantially rectangular profile.

3. The fastener of claim 1, further comprising a sealer configured to extend over the disk of the lock.

4. The fastener of claim 3, wherein the sealer is sized and shaped to radially extend from the disk of the lock to create a sealing between the first part and the second part.

5. The fastener of claim 1, wherein the retainer further comprises two or more arms configured to receive and engage the head of the lock to retain the lock inside the retainer.

6. The fastener of claim 5, wherein the head of the lock is tapered such that the head of the lock can move past the two or more arms of the retainer and be stopped from moving back.

7. The fastener of claim 1, wherein the lock comprises nylon and glass fiber.

8. The fastener of claim 1, wherein the retainer comprises plastic.

9. The fastener of claim 1, wherein the sealer comprises rubber.

10. The fastener of claim 1, wherein the screw comprises a tapping screw.

11. The fastener of claim 1, wherein the fastener is waterproof.

12. The fastener of claim 1, wherein rotating the screw in a second direction opposite the first direction causes the lock to rotate and the two blocks of the lock to enter the cavity of the retainer.

13. A fastener, comprising:
a lock comprising a body, a disk extending radially from a first end of the body, and one or more blocks extending from opposite sides of the body;
a retainer disposed over the lock, the retainer comprising:
a cavity extending between two openings on opposite sides of the retainer; and
a screw configured to enter through a second part and into the body of the lock;
wherein rotating the screw in a first direction causes the lock to rotate and the one or more blocks to protrude from the openings of the retainer, thereby securing a first part between the disk and the one or more blocks, and securing a second part between the disk of the lock and the screw.

14. The fastener of claim 13, wherein the retainer further comprises one or more snap fit joints disposed on an external surface of the retainer, and configured to fasten the first part.

15. The fastener of claim 13, wherein the retainer has a substantially rectangular profile.

16. The fastener of claim 13, wherein the body of the lock is substantially inside the cavity of the retainer.

17. The fastener of claim 13, wherein the one or more blocks of the lock are proximate the disk of the lock.

18. The fastener of claim 13, further comprising a sealer sized and shaped to radially extend from the disk of the lock and create a sealing between the first part and the second part.

19. The fastener of claim 13, wherein a second end of the body comprises a head that is tapered such that the head of the lock can move past two or more arms on the retainer and be stopped from moving back.

20. The fastener of claim 13, wherein rotating the screw in a second direction opposite the first direction causes the lock to rotate and the two blocks of the lock to enter the cavity of the retainer.
